(19) United States
(12) Patent Application Publication
(10) Pub. No.: US 2016/0063170 A1
(43) Pub. Date: Mar. 3, 2016

(54) MEMORY REDUNDANCY REDUCTION

(71) Applicant: QUALCOMM Incorporated, San Diego, CA (US)

(72) Inventors: Jentsung Lin, Carlsbad, CA (US); Paul Douglas Bassett, Austin, TX (US)

(21) Appl. No.: 14/473,898

(22) Filed: Aug. 29, 2014

(51) Int. Cl. G06F 17/50

(52) U.S. Cl. CPC G06F 17/5081; G06F 2217/06; G06F 2217/02

(57) ABSTRACT

A method includes designing, at a computer, a first version of a memory device that includes first main memory and first redundant memory. The method further includes modifying a design of the first version of the memory device to produce a second version of the memory device when an error rate associated with fabrication of the first version of the memory device is below a threshold. The second version of the memory device includes second main memory that is logically identical to the first main memory, and the second version of the memory device includes less redundant memory than the first redundant memory.

### I. FIELD

The present disclosure is generally related to memory redundancy reduction.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

The circuitry within wireless telephones and other electronic devices may include memory devices that include memory to store information. Data errors may occur at the memory, causing data read from the memory to differ from data written to the memory. The data errors may be transient (e.g., data errors that may be corrected by rewriting the data to the memory), or the data errors may be recurring (e.g., data errors that may not be corrected by rewriting the data to the memory). One way to correct a recurring data error to a memory location is by remapping a memory location corresponding to the recurring data error to a memory location of a redundant memory. Thus, the memory device may include a quantity of redundant memory. As the memory device is mass produced, a data error rate due to fabrication errors may decrease over time (e.g., as the fabrication process matures). Thus, a memory device with an initial fabrication data error rate may utilize more redundant memory than a memory device with a “mature” fabrication data error rate (e.g., a memory device designed according to a mature fabrication process).

### III. SUMMARY

Systems and methods to reduce memory redundancy on a memory device are disclosed. A first version of a memory device (e.g., a first chip) may be designed to include main memory and redundant memory. The main memory may include defective memory locations (e.g., storage elements at certain memory addresses) based on fabrication error. Data associated with the defective memory locations may be remapped to memory locations in the redundant memory. As fabrication of the first version of the memory device “matures,” the amount of defective memory locations in the main memory may be reduced. Thus, subsequent versions of the memory device may not need as much redundant memory as the first version of the memory device. When the amount of defective memory locations in the main memory is below a threshold, a second version of the memory device (e.g., a second chip) may be produced that includes less redundant memory than the first version of the memory device. For example, the second version of the memory device may include main memory (e.g., “matured” main memory) that is logically identical to the main memory (with the reduced amount of defective memory locations) of the first version of the memory device. In particular, the main memory of the first version of the memory device and the main memory of the second version of the memory device may be fabricated using an identical fabrication process. Because main memory of the second version of the memory device has a “mature” fabrication data error rate (e.g., a reduced fabrication data error rate), the second version of the memory device may be fabricated with less redundant memory to improve die area. In one aspect, a fixed voltage source may be used (instead of a redundant memory) on the second version of the chip to reduce an amount of die area consumed on the chip.

In a particular aspect, a method includes designing, at a computer, a first version of a memory device that includes first main memory and first redundant memory. The method further includes modifying a design of the first version of the memory device to produce a second version of the memory device when an error rate associated with fabrication of the first version of the memory device is below a threshold. The second version of the memory device includes second main memory that is logically identical to the first main memory, and the second version of the memory device includes less redundant memory than the first redundant memory.

In another particular aspect, an apparatus includes a second version of a memory device. The second version of the memory device includes a voltage source configured to present a fixed logical value during operation. The second version of the memory device also includes a second main memory. The second version of the memory device further includes second selection logic connected to the second main memory. A selection input of the selection logic is hard-wired to the voltage source to receive the fixed logical value such that the second version of the memory device includes less redundant memory than a first version of the memory device.

In another particular aspect, a non-transitory computer-readable medium includes instructions that, when executed by a processor, cause the processor to design a first version of a memory device that includes first main memory and first redundant memory. The instructions are also executable to cause the processor to modify a design of the first version of the memory device to produce a second version of the memory device when an error rate associated with fabrication of the first version of the memory device is below a threshold. The second version of the memory device includes second main memory that is logically identical to the first main memory. The second version of the memory device includes less redundant memory than the first redundant memory.

In another particular aspect, an apparatus includes means for designing a first version of a memory device that includes first main memory and first redundant memory. The apparatus further includes means for modifying a design of the first version of the memory device to produce a second version of the memory device when an error rate associated with fabrication of the first version of the memory device is below a threshold. The second version of the memory device includes second main memory that is logically identical to the first main memory, and the second version of the memory device includes less redundant memory than the first redundant memory.

One particular advantage provided by at least one of the disclosed aspects is an ability to reduce an amount of die area occupied by redundant memory on a memory device when a fabrication process associated with manufacturing the memory device has matured. Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a process to reduce an amount of die area occupied by redundant memory on a memory device based on fabrication maturity;

FIG. 2A is a diagram of a particular illustrative aspect of a first version of a memory device;

FIG. 2B is a diagram of a particular illustrative aspect of a second version of the memory device of FIG. 2A that has reduced redundant memory based on fabrication maturity;

FIG. 3A is a diagram of another particular illustrative aspect of a first version of a memory device;

FIG. 3B is a diagram of a particular illustrative aspect of a second version of the memory device of FIG. 3A that has reduced redundant memory based on fabrication maturity;

FIG. 4 is a flowchart of a particular aspect of a method for reducing an amount of die area occupied by redundant memory on a memory device based on fabrication maturity;

FIG. 5 is a block diagram of a wireless device; and

FIG. 6 is a data flow diagram of a particular illustrative aspect of a manufacturing process to manufacture electronic devices.

### V. DETAILED DESCRIPTION

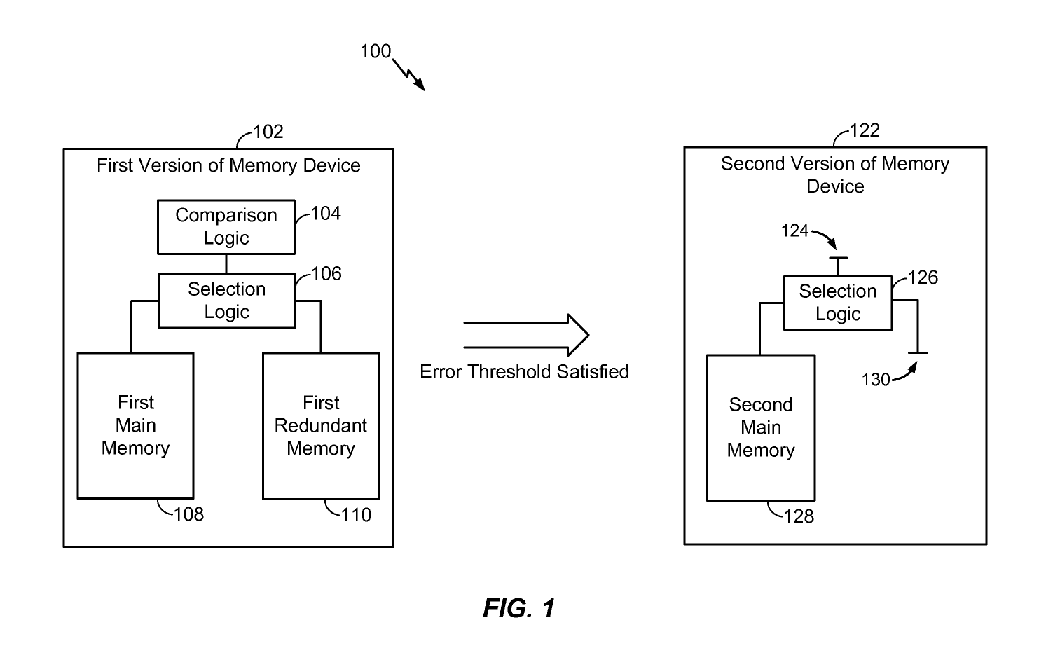

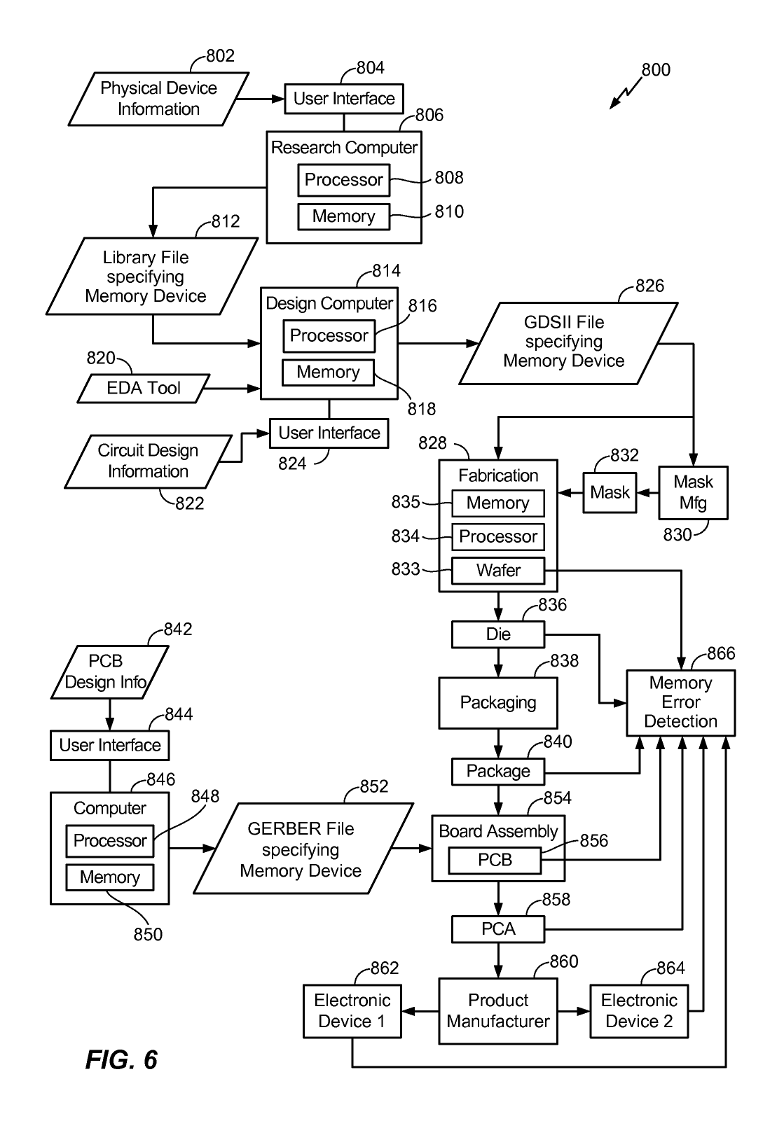

Referring to FIG. 1, a particular illustrative aspect of a process 100 to reduce an amount of die area occupied by redundant memory on a memory device based on fabrication maturity is shown. The process 100 may be implemented using fabrication techniques and/or fabrication equipment, as described with respect to FIG. 6.

A first version 102 of a memory device (e.g., a first chip) may be designed at a computer. For example, during a relatively early stage of manufacturing, the computer may generate a first mask to produce the first version 102 of the memory device. The first mask may function as a “blueprint” to manufacture the first version 102 of the memory device on a wafer. For example, the first mask may be used during photolithography (and other wafer fabrication techniques such as wet etching, dry etching, deposition, planarization, etc.) to manufacture components of the first version 102 of the memory device on the wafer.

The first version 102 of the memory device may include comparison logic 104, first selection logic 106, a first main memory 108, and a first redundant memory 110. Each component 104-110 of the first version 102 of the memory device may be fabricated on the wafer using the first mask. In a particular aspect, the first mask may correspond to multiple masks that are used at different stages during manufacture of the first version 102 of the memory device.

The comparison logic 104 may be configured to determine whether a particular memory address in the first main memory 108 corresponds to a storage element that is defective. For example, during the chip manufacturing process, errors may occur that result in portions (e.g., rows and/or columns) of the first main memory 108 becoming defective. During testing of the first version 102 of the memory device, the portions (e.g., rows and/or columns) of the first main memory 108 may be identified as faulty (e.g., defective). Memory addresses of the defective portions may be provided to the comparison logic 104, and data for the defective memory addresses may be replicated in the first redundant memory 110.

The comparison logic 104 may receive a particular memory address on which a particular operation (e.g., a read operation or a write operation) is to be performed. The comparison logic 104 may compare at least a portion (e.g., a row or a column) of the particular memory address to the defective portions of the first main memory 108 identified during testing.

In response to a determination that the portion of the particular memory address matches a defective portion of the first main memory 108 identified during testing, the comparison logic 104 may generate a first logical voltage signal (e.g., a logical “1” signal) to indicate a “match.” The first logical voltage signal may be provided to the first selection logic 106. In response to a determination that the portion of the particular memory address does not match a defective portion of the first main memory 108 identified during testing, the comparison logic 104 may generate a second logical voltage signal (e.g., a logical “0” signal) to indicate a “non-match.” The second logical voltage signal may be provided to the first selection logic 106.

Based on the signal received from the comparison logic 104, the first selection logic 106 may be configured to select between the first main memory 108 and the first redundant memory 110 for the operation. As a non-limiting example, the first selection logic 106 may include a multiplexer. In response to receiving a first logical voltage signal from the comparison logic 104 (e.g., indicating that the particular address in the first main memory 108 matches a defective address), the multiplexer may select a corresponding address from the first redundant memory 110. In response to receiving a second logical voltage signal from the comparison logic 104 (e.g., indicating that the particular address in the first main memory 108 does not match a defective address), the multiplexer may select the particular address from the first main memory 108.

Over time, fabrication of the first version 102 of the memory device may become increasingly mature. For example, an amount of errors that occur during manufacturing of first versions 102 of the memory device may decrease over time. Decreasing the amount of errors during manufacturing may result in a reduced amount of defective portions (e.g., columns and/or rows) in the first main memories 108 of the first versions 102 of the memory device. For example, during testing of the “later versions” of the first version 102 of the memory device, a computer may determine that there are a reduced number (or zero) defective portions in the first main memory 108 (e.g., determine that fabrication of the first version 102 of the memory device has become mature).

When an error rate associated with fabrication of the first version 102 of the memory device satisfies an error threshold (e.g., when the computer determines (during testing) that a number of defective portions in the first main memory 108 is below a threshold), the computer may modify the design of the first version 102 of the memory device to produce a second version 122 of the memory device. For example, modifying the design of the first version 102 of the memory device may include modifying the first mask associated with the first version 102 of the memory device to generate a second mask associated with the second version 122 of the memory device. The second mask may function as a “blueprint” to manufacture the second version 122 of the memory device on a wafer. For example, the second mask may be used during photolithography (and other wafer fabrication techniques) to manufacture components of the second version 122 of the memory device on the wafer. It should be understood that the second version 122 of the memory device is a separate device that includes components having identical logic to the first version 102 of the memory device.

The second version 122 of the memory device may include second selection logic 126 and a second main memory 128. Each component of the second version 122 of the memory device may be fabricated on the wafer using the second mask. In a particular aspect, the second mask may correspond to multiple masks that are used at different stages during manufacture of the second version 122 of the memory device. The second selection logic 126 may be logically identical to the first selection logic 106, and the second main memory 128 may be logically identical to the first main memory 108. For example, the second selection logic 126 may be “corresponding selection logic” of the first selection logic 106. The second main memory 128 may be manufactured on the wafer using the “matured fabrication process” that was used to manufacture the first main memory 108 with the reduced number of defective portions.

Because the second main memory 128 includes a reduced number of defective portions (e.g., rows and/or columns), the second version 122 of the memory device may include less redundant memory than the first redundant memory 110. In the illustrated aspect, the second version 122 of the memory device includes a first voltage source 124 coupled (e.g., hard-wired) to a selection input of the second selection logic 126, and the second version 122 of the memory device also includes a second voltage source 130 coupled (e.g., hard-wired) to a redundant data input of the second selection logic 126. For example, in the illustrated aspect, the second version 122 of the memory device may not include any redundant memory.

The first voltage source 124 may provide a first fixed logical value to the selection input of the second selection logic 126. For example, the first voltage source 124 may be a ground voltage that provides a logical low voltage signal (e.g., a logical “0” voltage signal) to the second selection logic 126. The second selection logic 126 may operate in a substantially similar manner as the first selection logic 106. For example, upon receiving the logical low voltage signal, the second selection logic 126 may select a particular address from the second main memory 128. The second voltage source 130 may have a second fixed logical value. For example, because the second selection logic 126 selects a memory address in the second main memory 128, the second version 122 of the memory device does not need a redundant memory. Thus, the second version 122 of the memory device may include the second voltage source 130 instead of a redundant memory to reduce area (e.g., die) consumption. The second voltage source 130 may be configured to provide a voltage signal having a constant voltage level to the second selection logic 124. It will be appreciated that hard-wiring the second selection logic 126 to the first voltage source 124 (instead of to comparison logic) may also reduce area consumption.

In another particular aspect, the second version 122 of the memory device may include second comparison logic (not shown) instead of the first voltage source 124, and the second version 122 of the memory device may also include second redundant memory (not shown) instead of the second voltage source 130. The second comparison logic and the second redundant memory may be “smaller” than the comparison logic 104 and the first redundant memory 110, respectively, of the first version 102 of the memory device. For example, because the second main memory 128 is mature (e.g., includes a reduced amount of defective portions), a reduced amount of comparison logic is needed for the second version 122 of the memory device. Certain portions of the first redundant memory 110 may be changed to (e.g., replaced by) a voltage source in the second version 122 of the memory device to produce the smaller second redundant memory. In a similar manner, because the second main memory 128 is mature, a reduce amount of redundant memory is needed for the second version 122 of the memory device.

It will be appreciated that modifying the design of the first version 102 of the memory device to produce the second version 122 of the memory device when the error threshold is satisfied may reduce an amount of die consumed by comparison logic and redundant memory. For example, the second version 122 of the memory device may include voltage sources 124, 130 that are hard-wired to the second selection logic 126 instead of relatively large comparison logic and redundant memory.

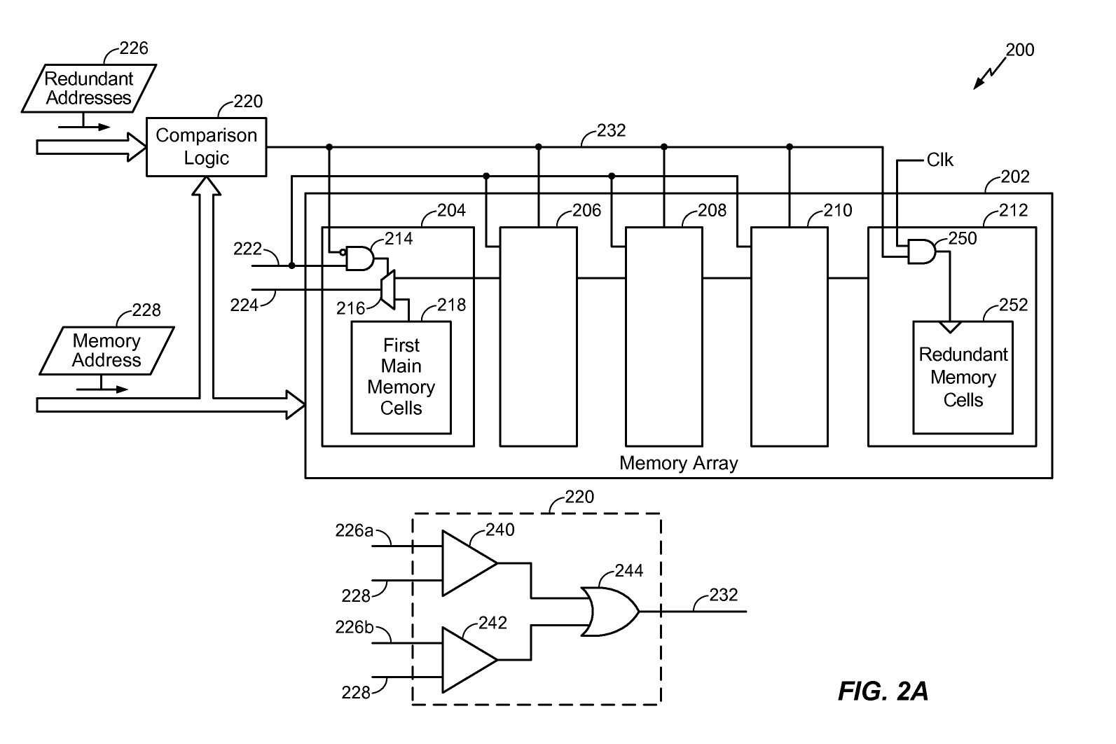

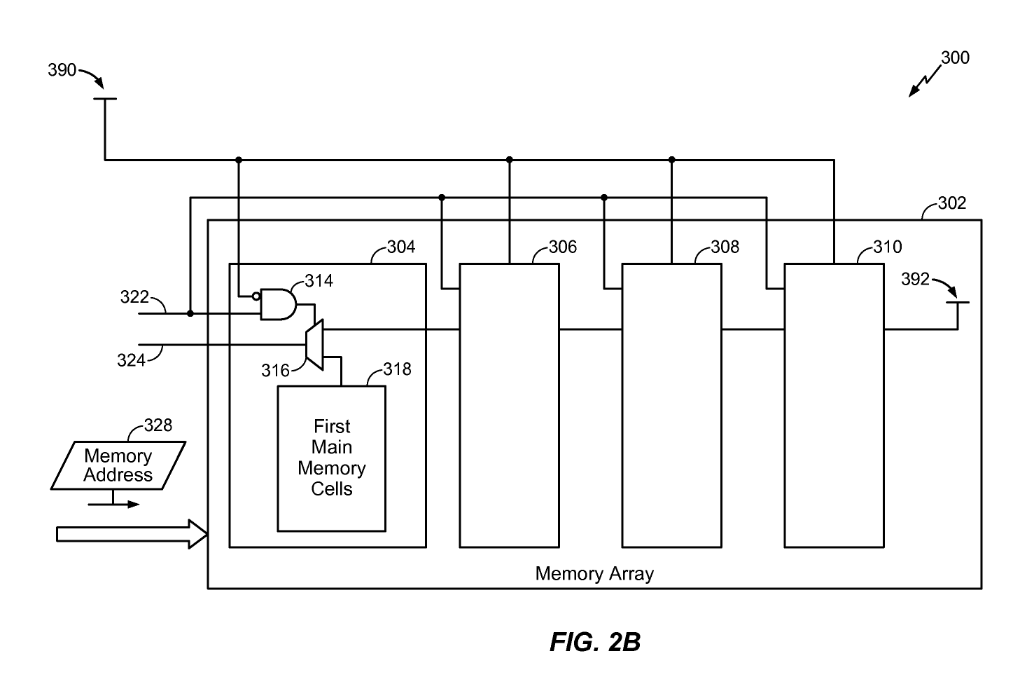

Referring to FIG. 2A, a particular illustrative aspect of a first version 200 of a memory device is shown. The first version 200 of the memory device may correspond to the first version 102 of the memory device of FIG. 1. The first version 200 of the memory device may include a memory array 202 and comparison logic 220. In a particular aspect, the comparison logic 220 may correspond to the comparison logic 104 of FIG. 1.

The memory array 202 may include one or more main memory banks 204-210 and a redundant memory bank 212. Each main memory bank 204-210 may include main memory cells and selection logic. As an illustrative example, the first main memory bank 204 may include first main memory cells 218 and first selection logic (e.g., a logical AND gate 214 and a multiplexer 216). The other main memory banks 206-210 may have a substantially similar configuration as the first main memory bank 204. The main memory cells and the selection logic in the main memory banks 204-210 may correspond to the first main memory 108 and the first selection logic 106, respectively, of the first version 102 of the memory device of FIG. 1. The redundant memory bank 212 may include a logical AND gate 250 and redundant memory cells 252. In a particular aspect, the logical AND gate 250 may be included in the first selection logic 106 of FIG. 1, and the redundant memory cells 252 may correspond to the first redundant memory 110 of FIG. 1.

The comparison logic 220 may be configured to determine whether a memory address 228 in one of the main memory banks 204-210 is defective. The memory address 228 may be provided to the comparison logic 220 along with addresses of defective portions of the main memory banks 204-210 (e.g., redundant addresses 226). As a non-limiting illustrative example, the comparison logic 220 may include a first comparator 240, a second comparator 242, and a logical OR gate 244. The memory address 228 may be provided to a first input of the first comparator 240 and to a first input of the second comparator 242. A first redundant address 226a may be provided to a second input of the first comparator 240, and a second redundant address 226b may be provided to a second input of the second comparator 242. The first comparator 240 may compare the memory address 228 to the first redundant address 226a to determine whether the addresses 226a, 228 “match.” In response to a determination that the addresses 226a, 228 match, the first comparator 240 may provide a logical high voltage signal to the logical OR gate 244. In response to a determination that the addresses 226a, 228 do not match, the first comparator 240 may provide a logical low voltage signal to the logical OR gate 244. The second comparator 242 may operate in a substantially similar manner as the first comparator 240 with respect to memory address 228 and the second redundant address 226b. In response to the logical OR gate 244 receiving a logical high voltage signal from the first comparator 240 or the second comparator 242, the logical OR gate 244 generates a match indication signal 232 having a logical high voltage level (e.g., indicating that the memory address 228 corresponds to a defective address). In response to the logical OR gate 244 receiving logical low voltage signals from the first comparator 240 and the second comparator 242, the logical OR gate 244 generates a match indication signal 232 having a logical low voltage level (e.g., indicating that the memory address 228 does not correspond to a defective address).

The match indication signal 232 may be inverted and provided to logical AND gates in the main memory banks 204-210, and the match indication signal 232 may be provided to the logical AND gate 250 in the redundant memory bank 212. For example, the logical AND gate 214 has an inverted input coupled to receive the match indication signal 232. A selection input signal 222 may also be provided to the logical AND gates in the main memory banks 204-210. The selection input signal 222 may indicate which memory bank 204-210 includes the requested data (e.g., which memory bank 204-210 is associated with the memory address 228). For example, if the memory address 228 is associated with the first main memory cells 218, the selection input signal 222 may provide a logical high voltage signal to the logical AND gate 214. Alternatively, if the memory address 228 is not associated with the first main memory cells 218, the selection input signal 222 may provide a logical low voltage signal to the logical AND gate 214.

The multiplexer 216 may output 224 data from the first main memory cells 218 when that logical AND gate 214 provides a logical high voltage signal to the selection input of the multiplexer 216 (e.g., when the comparison logic 220 does not indicate a “match” and when the memory address 228 is associated with the first main memory cells 218). Otherwise, the multiplexer 216 may output 224 data received from the selection logic of the second main memory bank 206, the third main memory bank 208, or the fourth main memory bank 210. The selection logic of the other main memory banks 206-210 may operate is a substantially similar manner as the logical AND gate 214 and the multiplexer 216.

When the match indication signal 232 has a logical high voltage level (e.g., indicating that the memory address 228 corresponds to a defective address), each AND gate 214 in the main memory banks 204-210 may provide a logical low voltage signal to a corresponding multiplexer 216, such that the output 224 corresponds to data accessed from the redundant memory cells 252. For example, in response to receiving the match indication signal 232, the logical AND gate 250 may provide a clock gating signal (CLK) to the redundant memory cells 252.

Referring to FIG. 2B, a particular illustrative aspect of a second version 300 of the memory device in FIG. 2A is shown. The second version 300 of the memory device may be a device that results from modifying the design (e.g., the mask) of the first version 200 of the memory device. For example, when an error rate associated with fabrication of the first version 200 of the memory device satisfies a threshold (e.g., when a computer determines during testing that a number of defective portions of the memory banks 204-210 is below a threshold), the computer may modify a mask associated with the first version 200 of the memory device to produce the second version 300 of the memory device. The second version 300 of the memory device may correspond to the second version 122 of the memory device of FIG. 1.

The second version 300 of the memory device includes a memory array 302. The memory array 302 may include one or more main memory banks 304-310. The main memory banks 304-310 may be logically identical to “matured” main memory banks 204-210 in the first version 200 of the memory device. For example, the matured main memory banks 204-210 may correspond to main memory banks 204-210 having a number of defective portions below the threshold. Each main memory bank 304-310 may include selection logic. For example, the first main memory bank 304 may include a logical AND gate 314 and a multiplexer 316, and the other main memory banks 306-310 may include similar selection logic.

Because the main memory banks 304-310 include a reduced number of defective portions, the second version 300 of the memory device may include less redundant memory than the first version 200 of the memory device. In the illustrated aspect, the second version 300 of the memory device includes a first voltage source 390 coupled (e.g., hard-wired) to an inverted input of the logical AND gate 314 (e.g., the selection logic). The first voltage source 390 may provide a first fixed logical value to the inverted input of the logical AND gate 314. For example, the first voltage source 390 may be a ground voltage that provides a logical low voltage signal (e.g., a logical “0” voltage signal) to the inverted input of the logical AND gate 314. Logical AND gates in the other main memory banks 306-310 may be coupled to receive the first fixed logical value from the first voltage source 390 in a substantially similar manner as the logical AND gate 314.

Based on a selection input signal 322, the first fixed logical value may enable the logical AND gate 314 to provide a logical high voltage signal to the multiplexer 316. For example, the selection input signal 322 may indicate which main memory bank 304-310 includes requested data (e.g., which memory bank 304-310 is associated with a memory address 328). If the memory address 328 is associated with first main memory cells 318 in the first main memory bank 304, the selection input signal 322 may provide a logical high voltage signal to the logical AND gate 314, and the multiplexer 316 may output 324 the requested data from the first main memory cells 318. Data from memory cells in the other main memory banks 306-310 may be output 324 based on the selection input signal 322 in a similar manner.

Because the selection logic outputs data from one of the main memory banks 304-310, the second version 300 of the memory device does not need a redundant memory. Thus, the second version 300 of the memory device may include a second voltage source 392 instead of a redundant memory to reduce die area consumption. It will be appreciated that hard-wiring the selection logic of the main memory banks 304-310 to the first voltage source 390 and to the second voltage source 392 (instead of the comparison logic 220 and the redundant memory bank 212 as in the first version 200 of the memory device) may reduce die area consumption.

It will be appreciated that a mask used to design the memory device illustrated in FIG. 2A may be changed to produce the memory device illustrated in FIG. 2B. For example, the portion of the mask used to produce the redundant memory bank 212 in FIG. 2A may be modified to produce the second voltage source 392. Modifying this portion of the mask may be less burdensome (and less prone to errors) than modifying other portions of the mask (or creating a new mask). For example, because the redundant memory bank 212 is physically isolated from the main memory banks 204-210 (as compared to each main memory bank 204-210 having an attached redundant memory row), modifying the mask to remove the redundant memory bank 212 from subsequent devices may be “easier” than modifying the mask to remove a redundant memory row attached to each main memory bank 204-210.

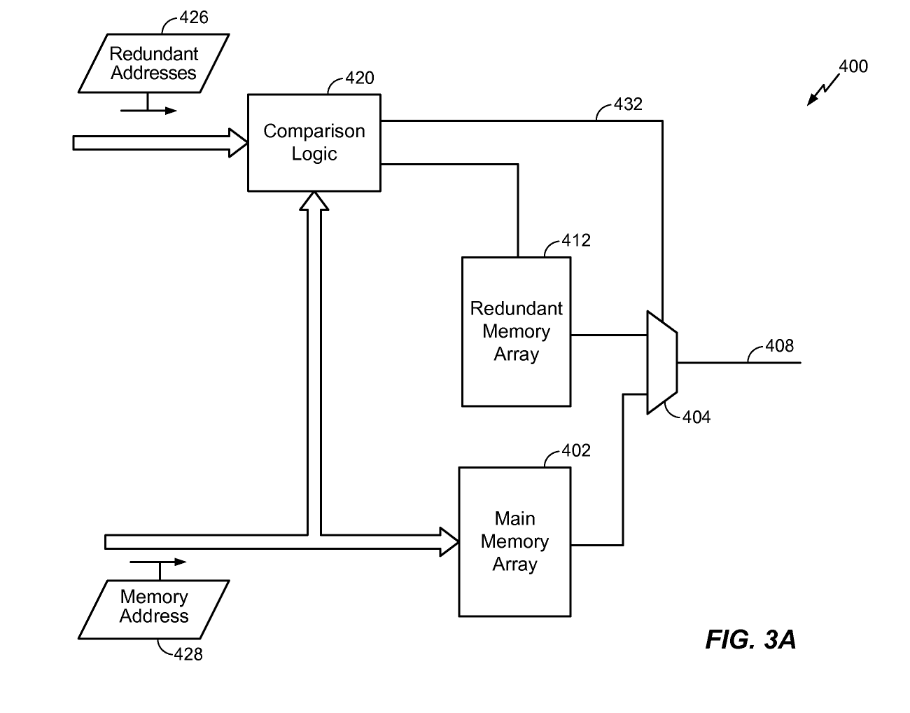

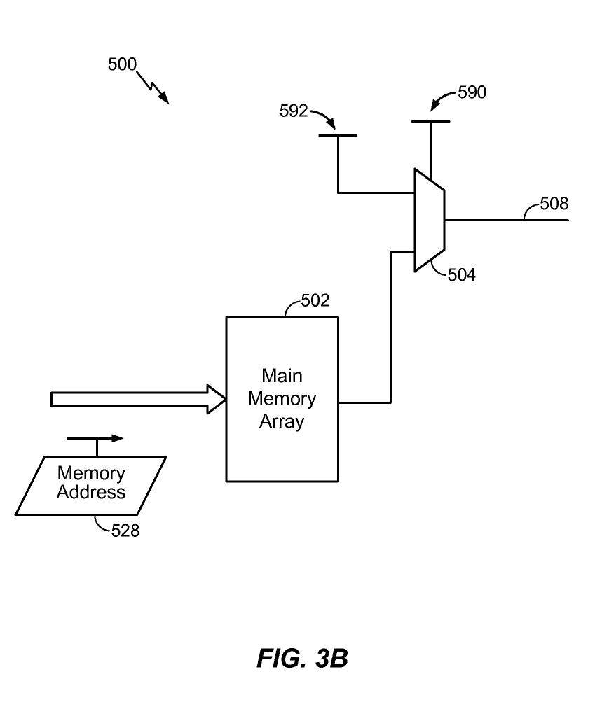

Referring to FIG. 3B, a particular illustrative aspect of a first version 400 of a memory device is shown. The first version 400 of the memory device may correspond to the first version 102 of the memory device of FIG. 1. The first version 400 of the memory device may include a main memory array 402, a redundant memory array 412, a multiplexer 404 (e.g., selection logic), and comparison logic 420. In a particular aspect, the main memory array 402 may correspond to the first main memory 108 of FIG. 1, the redundant memory array 412 may correspond to the first redundant memory 110 of FIG. 1, the multiplexer 404 may correspond to the selection logic 106 of FIG. 1, and the comparison logic 420 may correspond to the comparison logic 104 of FIG. 1.

During operation, a memory address 428 may be provided to the main memory array 402 and to the comparison logic 420. The main memory array 402 may provide data associated with the memory address 428 to a first input of the multiplexer 404. The comparison logic 420 may compare the memory address 428 to one or more redundant addresses 426 to determine whether the memory address 428 in the main memory array 402 is defective. The comparison logic 420 may operate in a substantially similar manner as the comparison logic 220 of FIG. 2.

In response to a determination that the memory address 428 “matches” a redundant address 426 (e.g., the memory address 428 corresponds to a defective address), the comparison logic 420 may generate a match indication signal 432 having a first logic voltage level (e.g., a logic high voltage level) and provide the match indication signal 432 to a selection input of the multiplexer 404. The comparison logic may also provide the “matching” redundant address 426 to the redundant memory array 412. In response to a determination that the memory address 428 does not match a redundant address 426 (e.g., the memory address 428 does not correspond to a defective address), the comparison logic may generate a match indication signal 432 having a second logic voltage level (e.g., a logic low voltage level) and provide the match indication signal 432 to the selection input of the multiplexer 404.

The multiplexer 404 may be configured to output data 408 associated with the memory address 428 from the main memory array 402 in response to receiving a second logic voltage signal (e.g., a logic low voltage signal) at the selection input (indicating that the memory address 428 in the main memory array 402 does not correspond to a defective address). The multiplexer 404 may be configured to output data 408 associated with the “matching” redundant address 426 from the redundant memory array 412 in response to receiving a first logic voltage signal (e.g., a logic high voltage signal) at the selection input (indicating that the memory address 428 in the main memory array 402 corresponds to a defective address).

Referring to FIG. 3B, a particular illustrative aspect of a second version 500 of the memory device in FIG. 3A is shown. The second version 500 of the memory device may be a device that results from modifying the design (e.g., the mask) of the first version 400 of the memory device. For example, when an error rate associated with fabrication of the first version 400 of the memory device satisfies a threshold (e.g., when a computer determines during testing that a number of defective portions of the main memory array 402 is below a threshold), the computer may modify a mask associated with the first version 400 of the memory device to produce the second version 500 of the memory device. The second version 500 of the memory device may correspond to the second version 122 of the memory device of FIG. 1.

The second version 500 of the memory device includes a main memory array 502 and a multiplexer 504. The main memory array 502 may be logically identical to the “matured” main memory array 402 in the first version 400 of the memory device. For example, the matured main memory array 502 may correspond to the main memory array 402 having a number of defective portions below the threshold. The multiplexer 504 may be logically identical to the multiplexer 404 in the first version 400 of the memory device.

Because the main memory array 502 includes a reduced number of defective portions, the second version 500 of the memory device may include less redundant memory than the first version 400 of the memory device. In the illustrated aspect, the second version 500 of the memory device includes a first voltage source 590 coupled (e.g., hard-wired) to a selection input of the multiplexer 504. The first voltage source 590 may provide a first fixed logical value to the selection input of the multiplexer 504. For example, the first voltage source 590 may be a ground voltage that provides a logical low voltage signal (e.g., a logical “0” voltage signal) to the selection input of the multiplexer 504. Based on the ground voltage, the multiplexer 504 outputs data 508 associated with a memory address 528 from the main memory array 502.

Because the selection logic is hard-wired to output data 508 from the main memory array 502, the second version 500 of the memory device does not need a redundant memory. Thus, the second version 500 of the memory device may include a second voltage source 592 hard-wired to the multiplexer 504 (instead of a redundant memory) to reduce die area consumption. It will be appreciated that hard-wiring the multiplexer 504 to the first voltage source 590 and to the second voltage source 592 (instead of the comparison logic 420 and the redundant memory array 412 as in the first version 400 of the memory device) reduces die area consumption.

Although the illustrations in FIGS. 2A-2B exemplify that the second versions 122, 300, 500 of the memory devices do not include any redundant memory, in other aspects, the second versions 122, 300, 500 of the memory devices may include “less” redundant memory than the first versions 102, 200, 400 of the memory devices. For example, portions of the masks used to produce the redundant memory in the first versions 102, 200, 400 of the memory devices may be modified to produce voltage sources. Accordingly, portions of the masks used to produce the selection logic in the first versions 102, 200, 400 of the memory devices may also be modified to bypass selection of the voltage sources.

As a non-limiting example, the first versions 102, 200, 400 of the memory devices may include a plurality of redundant memory cells. Each redundant memory cell of the plurality of redundant memory cells may correspond to a memory address in a main memory that includes a defective storage element. As fabrication of the first versions 102, 200, 400 of the memory devices matures, the number of redundant memory cells may decrease gradually or incrementally in subsequent versions of the memory devices based on the number of defective storage elements in the main memory. For example, a first subset of the plurality of redundant memory cells in a first subsequent version of the memory device may be replaced by voltage sources in response to a determination that the number of defective storage elements in the main memory is below a first threshold. The first subset and a second subset of the plurality of redundant memory cells in a second subsequent version of the memory device may be replaced by voltage sources in response to a determination that the number of defective storage elements in the main memory is below a second threshold that is greater than the first threshold, etc.

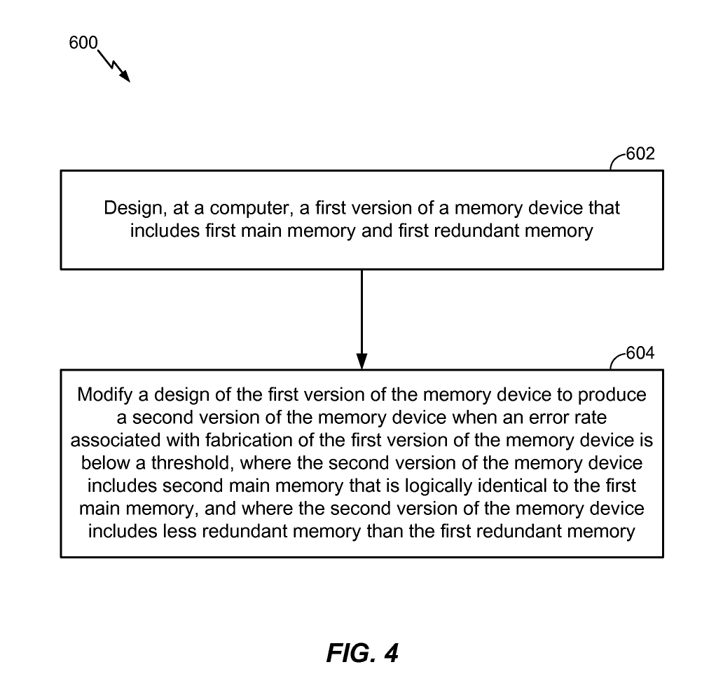

Referring to FIG. 4, a flowchart of a particular aspect of a method 600 for reducing an amount of die area occupied by redundant memory on a memory device based on fabrication maturity is shown. The method 600 may be implemented using fabrication techniques and/or a computer associated with fabrication equipment, as described with respect to FIG. 6.

The method 600 includes designing, at a computer, a first version of a memory device that includes first main memory and first redundant memory, at 602. For example, referring to FIG. 1, a computer may design the first version 102 of the memory device. The first version 102 of the memory device may include the first main memory 108 and the first redundant memory 110.

A design of the first version of the memory device may be modified to produce a second version of the memory device when an error rate associated with fabrication of the first version of the memory device is below a threshold, at 604. For example, referring to FIG. 1, when the error rate associated with fabrication of the first version 102 of the memory device satisfies the error threshold (e.g., when the computer determines (during testing) that a number of defective portions in the first main memory 108 is below a threshold), the computer may modify the design of the first version 102 of the memory device to produce the second version 122 of the memory device. Modifying the design of the first version 102 of the memory device may include modifying the first mask associated with the first version 102 of the memory device to generate a second mask associated with the second version 122 of the memory device.

The second version 122 of the memory device may include the second main memory 128 that is logically identical to the first main memory 108. Because the second main memory 128 includes a reduced number of defective portions (e.g., rows and/or columns), the second version 122 of the memory device may include less redundant memory than the first redundant memory 110. For example, the second version 122 of the memory device includes the first voltage source 124 coupled (e.g., hard-wired) to the selection input of the second selection logic 126, and the second version 122 of the memory device also includes a second voltage source 130 coupled (e.g., hard-wired) to the redundant data input of the second selection logic 126. For example, in the illustrated aspect of FIG. 1, the second version 122 of the memory device may not include any redundant memory.

A second version of a memory device having reduced redundant memory may operate in a substantially similar manner as a first version of a memory device having a “standard” amount of redundant memory. Portions of the redundant memory in the second version of the memory device that correspond to “non-defective” storage elements in main memory of the second version of the memory device may be replaced with voltage sources. Selection logic of the second version of the memory device may be configured to bypass the portions of the redundant memory in the second version of the memory device and select the “non-defective” storage element in the main memory.

The method 600 of FIG. 4 may reduce an amount of die consumed by comparison logic and redundant memory by modifying the design of the first version 102 of the memory device to produce the second version 122 of the memory device when the error threshold is satisfied. For example, the second version 122 of the memory device may include voltage sources 124, 130 that are hard-wired to the second selection logic 126 instead of relatively large comparison logic and redundant memory. Modifying the mask used to design the first version 102 of the memory device may be less burdensome and more economical than a conventional redesign of the first version 102 of the memory device.

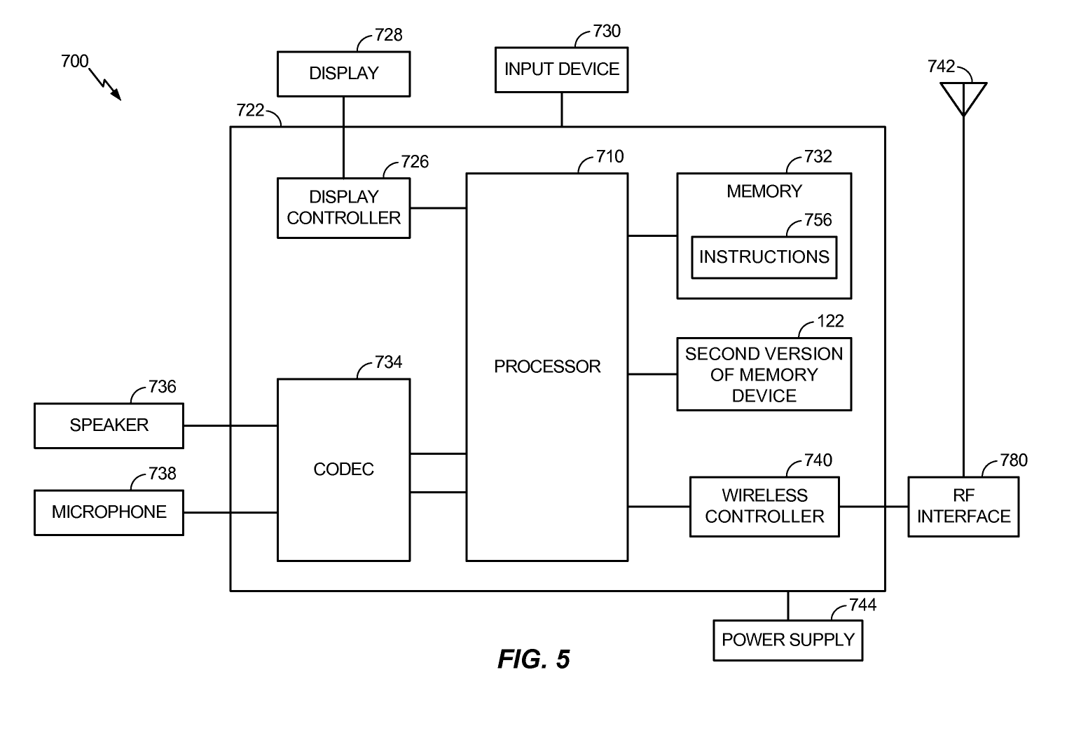

Referring to FIG. 5, a block diagram of an electronic device 700 is shown. The electronic device 700 includes the second version 122 of the memory device of FIG. 1 generated using the process 100 of FIG. 1. In a particular aspect, the electronic device 700 is a wireless device. The device 700 includes a processor 710, such as a digital signal processor (DSP), coupled to a memory 732.

FIG. 5 also shows a display controller 726 that is coupled to the processor 710 and to a display 728. A coder/decoder (CODEC) 734 can also be coupled to the processor 710. A speaker 736 and a microphone 738 can be coupled to the CODEC 734. FIG. 5 also indicates that a wireless controller 740 can be coupled to the processor 710. The wireless controller 740 may also be coupled to an antenna 742 via a radio frequency (RF) interface 780.

The memory 732 may be a tangible non-transitory processor-readable storage medium that includes executable instructions 756. The instructions 756 may be executed by a processor, such as the processor 710. In a particular aspect, the processor 710 may correspond to a memory controller configured to provide a memory address (e.g., the memory addresses 328, 528) to the second main memory 128 of the second version 122 of the memory device.

In a particular aspect, the processor 710, the display controller 726, the memory 732, the second version 122 of the memory device, the CODEC 734, and the wireless controller 740 are included in a system-in-package or system-on-chip device 722. In a particular aspect, an input device 730 and a power supply 744 are coupled to the system-on-chip device 722. Moreover, in a particular aspect, as illustrated in FIG. 5, the display 728, the input device 730, the speaker 736, the microphone 738, the antenna 742, and the power supply 744 are external to the system-on-chip device 722. However, each of the display 728, the input device 730, the speaker 736, the microphone 738, the wireless antenna 742, and the power supply 744 can be coupled to a component of the system-on-chip device 722, such as an interface or a controller.

The foregoing disclosed devices and functionalities may be designed and configured into computer files (e.g. RTL, GDSII, GERBER, etc.) stored on computer-readable media. Some or all such files may be provided to fabrication handlers to fabricate devices based on such files. Resulting products include wafers that are then cut into dies and packaged into chips. The chips are then employed in devices described above. FIG. 6 depicts a particular illustrative aspect of an electronic device manufacturing process 800.

Physical device information 802 is received at the manufacturing process 800, such as at a research computer 806. The physical device information 802 may include design information representing at least one physical property of an electronic device that includes one or more memories, such as the first version 102 of the memory device of FIG. 1 and/or the second version 122 of the memory device of FIG. 1. For example, the physical device information 802 may include physical parameters, material characteristics, and structure information that is entered via a user interface 804 coupled to the research computer 806. The research computer 806 includes a processor 808, such as one or more processing cores, coupled to a computer-readable medium such as a memory 810. The memory 810 may store computer-readable instructions that are executable to cause the processor 808 to transform the physical device information 802 to comply with a file format and to generate a library file 812.

In a particular aspect, the library file 812 includes at least one data file including the transformed design information. For example, the library file 812 may include a library of electronic devices (e.g., semiconductor devices) that includes one or more memories, such as the first version 102 of the memory device of FIG. 1 and/or the second version 122 of the memory device of FIG. 1, provided for use with an electronic design automation (EDA) tool 820.

The library file 812 may be used in conjunction with the EDA tool 820 at a design computer 814 including a processor 816, such as one or more processing cores, coupled to a memory 818. The EDA tool 820 may be stored as processor executable instructions at the memory 818 to enable a user of the design computer 814 to design a circuit that includes one or more memories, such as the first version 102 of the memory device of FIG. 1 and/or the second version 122 of the memory device of FIG. 1, using the library file 812. For example, a user of the design computer 814 may enter circuit design information 822 via a user interface 824 coupled to the design computer 814. The circuit design information 822 may include design information representing at least one physical property of an electronic device that includes one or more memories, such as the first version 102 of the memory device of FIG. 1 and/or the second version 122 of the memory device of FIG. 1. To illustrate, the circuit design property may include identification of particular circuits and relationships to other elements in a circuit design, positioning information, feature size information, interconnection information, or other information representing a physical property of an electronic device.

The design computer 814 may be configured to transform the design information, including the circuit design information 822, to comply with a file format. To illustrate, the file formation may include a database binary file format representing planar geometric shapes, text labels, and other information about a circuit layout in a hierarchical format, such as a Graphic Data System (GDSII) file format. The design computer 814 may be configured to generate a data file including the transformed design information, such as a GDSII file 826 that includes information describing one or more memories, such as the first version 102 of the memory device of FIG. 1 and/or the second version 122 of the memory device of FIG. 1, in addition to other circuits or information. In a particular aspect, the design computer 814 may generate a data file that identifies design changes between the first version 102 of the memory device of FIG. 1 and the second version 122 of the memory device of FIG. 1 to facilitate changing the mask of the first version 102 of the memory device to produce the second version 122 of the memory device. To illustrate, the data file may include information corresponding to a system-on-chip (SOC) or a chip interposer component that includes one or more memories, such as the first version 102 of the memory device of FIG. 1 and/or the second version 122 of the memory device of FIG. 1, and that also includes additional electronic circuits and components within the SOC.

The GDSII file 826 may be received at a fabrication process 828 to manufacture one or more memories, such as the first version 102 of the memory device of FIG. 1 and/or the second version 122 of the memory device of FIG. 1 according to transformed information in the GDSII file 826. For example, a device manufacture process may include providing the GDSII file 826 to a mask manufacturer 830 to create one or more masks, such as masks to be used with photolithography processing, illustrated in FIG. 8 as a representative mask 832. The mask 832 may be used during the fabrication process to generate one or more wafers 833, which may be tested and separated into dies, such as a representative die 836. In a particular aspect, the mask 832 may be changed to generate the second version 122 of the memory device of FIG. 1 based on a previous mask used to generate the first version 102 of the memory device of FIG. 1. The die 836 includes a circuit including one or more memories, such as the first version 102 of the memory device of FIG. 1 and/or the second version 122 of the memory device of FIG. 1.

In a particular aspect, the fabrication process 828 may be initiated by or controlled by a processor 834. The processor 834 may access a memory 835 that includes executable instructions such as computer-readable instructions or processor-readable instructions. The executable instructions may include one or more instructions that are executable by a computer, such as the processor 834.

The fabrication process 828 may be implemented by a fabrication system that is fully automated or partially automated. For example, the fabrication process 828 may be automated and may perform processing steps according to a schedule. The fabrication system may include fabrication equipment (e.g., processing tools) to perform one or more operations to form an electronic device. For example, the fabrication equipment may be configured to form integrated circuit elements using integrated circuit manufacturing processes (e.g., wet etching, dry etching, deposition, planarization, lithography, or a combination thereof).

The fabrication system may have a distributed architecture (e.g., a hierarchy). For example, the fabrication system may include one or more processors, such as the processor 834, one or more memories, such as the memory 835, and/or controllers that are distributed according to the distributed architecture. The distributed architecture may include a high-level processor that controls or initiates operations of one or more low-level systems. For example, a high-level portion of the fabrication process 828 may include one or more processors, such as the processor 834, and the low-level systems may each include or may be controlled by one or more corresponding controllers. A particular controller of a particular low-level system may receive one or more instructions (e.g., commands) from a high-level system, may issue sub-commands to subordinate modules or process tools, and may communicate status data back to the high-level system. Each of the one or more low-level systems may be associated with one or more corresponding pieces of fabrication equipment (e.g., processing tools). In a particular aspect, the fabrication system may include multiple processors that are distributed in the fabrication system. For example, a controller of a low-level system component of the fabrication system may include a processor, such as the processor 834.

Alternatively, the processor 834 may be a part of a high-level system, subsystem, or component of the fabrication system. In another aspect, the processor 834 includes distributed processing at various levels and components of a fabrication system.

Thus, the memory 835 may include processor-executable instructions that, when executed by the processor 834, cause the processor 834 to initiate or control formation of one or more memories, such as the first version 102 of the memory device of FIG. 1 and/or the second version 122 of the memory device of FIG. 1.

The die 836 may be provided to a packaging process 838 where the die 836 is incorporated into a representative package 840. For example, the package 840 may include the single die 836 or multiple dies, such as a system-in-package (SiP) arrangement. The package 840 may be configured to conform to one or more standards or specifications, such as Joint Electron Device Engineering Council (JEDEC) standards.

Information regarding the package 840 may be distributed to various product designers, such as via a component library stored at a computer 846. The computer 846 may include a processor 848, such as one or more processing cores, coupled to a memory 850. A printed circuit board (PCB) tool may be stored as processor executable instructions at the memory 850 to process PCB design information 842 received from a user of the computer 846 via a user interface 844. The PCB design information 842 may include physical positioning information of a packaged electronic device on a circuit board, the packaged electronic device corresponding to the package 840 including one or more memories, such as the first version 102 of the memory device of FIG. 1 and/or the second version 122 of the memory device of FIG. 1.

The computer 846 may be configured to transform the PCB design information 842 to generate a data file, such as a GERBER file 852 with data that includes physical positioning information of a packaged electronic device on a circuit board, as well as layout of electrical connections such as traces and vias, where the packaged electronic device corresponds to the package 840 including one or more memories, such as the first version 102 of the memory device of FIG. 1 and/or the second version 122 of the memory device of FIG. 1. In other aspects, the data file generated by the transformed PCB design information may have a format other than a GERBER format.

The GERBER file 852 may be received at a board assembly process 854 and used to create PCBs, such as a representative PCB 856, manufactured in accordance with the design information stored within the GERBER file 852. For example, the GERBER file 852 may be uploaded to one or more machines to perform various steps of a PCB production process. The PCB 856 may be populated with electronic components including the package 840 to form a representative printed circuit assembly (PCA) 858.

The PCA 858 may be received at a product manufacturer 860 and integrated into one or more electronic devices, such as a first representative electronic device 862 and a second representative electronic device 864. As an illustrative, non-limiting example, the first representative electronic device 862, the second representative electronic device 864, or both, may be selected from a mobile phone, a tablet, a computer, a communications device, a set top box, a music player, a video player, an entertainment unit, a navigation device, a personal digital assistant (PDA), and a fixed location data unit, into which one or more memories, such as the first version 102 of the memory device of FIG. 1 and/or the second version 122 of the memory device of FIG. 1, is integrated. As another illustrative, non-limiting example, one or more of the representative electronic devices 862 and 864 may be remote units such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof. Although FIG. 6 illustrates remote units according to teachings of the disclosure, the disclosure is not limited to these illustrated units. Aspects of the disclosure may be suitably employed in any device which includes active integrated circuitry including memory and on-chip circuitry.

A device that includes one or more memories, such as the first version 102 of the memory device of FIG. 1 and/or the second version 122 of the memory device of FIG. 1, may be fabricated, processed, and incorporated into an electronic device, as described in the illustrative manufacturing process 800. Although various representative stages are depicted with reference to FIG. 6, in other aspects fewer stages may be used or additional stages may be included. Similarly, the process 800 of FIG. 6 may be performed by a single entity or by one or more entities performing various stages of the manufacturing process 800.

A memory error detection process 866 may be performed at one or more stages of the process 800. For example, the memory error detection process 866 is performed at a production phase (e.g., during a fabrication phase, a packaging phase, an assembly phase or, a qualification phase) of the device fabricated by the process 800 (e.g., the first version 102 of the memory device of FIG. 1). During the memory error detection process 866, a computer may determine whether an error rate associated with fabrication of the first version 102 of the memory device satisfies an error threshold (e.g., determine whether a number of defective portions in the first main memory 108 is below a threshold). The memory error detection process 866 may be performed during a fabrication phase (e.g., on the wafer 833 or on the die 836), during a packaging phase (e.g., on the package 840), during an assembly phase (e.g., on the PCB 856), during a qualification phase (e.g., on the PCA 858), or a combination thereof. The qualification phase may also be performed by a product manufacturer and/or by a consumer (e.g., by performing the memory error detection process 866 on the representative electronic devices 862, 864). A version of the memory device may be changed in response to a determination that the error rate associated with fabrication of the first version 102 of the memory device satisfies the error threshold. For example, the second version 122 of the memory device may be generated in response to a determination that the error rate associated with fabrication of the first version 102 of the memory device satisfies the error threshold. Accordingly, the memory error detection process 866 may be performed by a single entity or by multiple entities.

In conjunction with the described aspects, an apparatus is disclosed that includes means for designing a first version of a memory device that includes first main memory and first redundant memory. For example, the means for designing the first version of the memory device may include one or more of the components of FIG. 6.

The apparatus may also include means for modifying a design of the first version of the memory device to produce a second version of the memory device when an error rate associated with fabrication of the first version of the memory device is below a threshold. The second version of the memory device includes second main memory that is logically identical to the first main memory, and the second version of the memory device includes less redundant memory than the first redundant memory. For example, the means for modifying the design of the first version of the memory device may include the design computer 814 of FIG. 6, the circuit design information 822 of FIG. 6, the memory 835 of FIG. 6, the processor 834 of FIG. 6, the mask 832 of FIG. 6, the die 836 of FIG. 6, components operable to perform the memory error detection process 866 of FIG. 6, etc.

Those of skill would further appreciate that the various illustrative logical blocks, configurations, modules, circuits, and algorithm steps described in connection with the aspects disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method comprising:
designing, at a computer, a first version of a memory device that includes first main memory and first redundant memory; and
modifying a design of the first version of the memory device to produce a second version of the memory device when an error rate associated with fabrication of the first version of the memory device is below a threshold, wherein the second version of the memory device includes second main memory that is logically identical to the first main memory, and wherein the second version of the memory device includes less redundant memory than the first redundant memory.

2. The method of claim 1, wherein modifying the design of the first version of the memory device to produce the second version of the memory device includes modifying a first mask associated with the first version of the memory device to generate a second mask associated with the second version of the memory device.

3. The method of claim 1, wherein the second version of the memory device does not include redundant memory.

4. The method of claim 1, wherein the first version of the memory device includes first selection logic configured to select between the first main memory and the first redundant memory for a particular operation, and wherein corresponding selection logic of the second version of the memory device is hard-wired to a voltage source.

5. The method of claim 4, wherein the corresponding selection logic of the second version of the memory device is configured to select the second main memory.

6. The method of claim 4, wherein the selection logic includes a multiplexer.

7. The method of claim 1, wherein the first version of the memory device includes first comparison logic to determine whether a particular address in the first main memory corresponds to a defective storage element, and wherein the second version of the memory device includes less comparison logic than the first comparison logic.

8. The method of claim 7, wherein the second version of the memory device does not include comparison logic.

9. An apparatus comprising:
a voltage source configured to present a fixed logical value during operation;
second main memory; and
second selection logic connected to the second main memory, wherein a selection input of the second selection logic is hard-wired to the voltage source to receive the fixed logical value;
wherein the voltage source, the second main memory, and the second selection logic are included in a second version of a memory device.

10. The apparatus of claim 9, wherein the second version of the memory device is generated by:
designing a first version of the memory device that includes first main memory and a first redundant memory; and
modifying a design of the first version of the memory device to produce the second version of the memory device when an error rate associated with fabrication of the first version of the memory device is below a threshold, wherein the second main memory is logically identical to the first main memory, and wherein the second version of the memory device includes less redundant memory than the first redundant memory.

11. The apparatus of claim 10, wherein modifying the design of the first version of the memory device to produce the second version of the memory device includes modifying a first mask associated with the first version of the memory device to generate a second mask associated with the second version of the memory device.

12. The apparatus of claim 10, wherein the second version of the memory device does not include redundant memory.

13. The apparatus of claim 10, wherein the first version of the memory device includes first selection logic configured to select between the first main memory and the first redundant memory for a particular operation, and wherein the second selection logic of the second version of the memory device corresponds to the first selection logic.

14. The apparatus of claim 9, wherein the second selection logic of the second version of the memory device is configured to select the second main memory.

15. The apparatus of claim 9, wherein the second selection logic includes a multiplexer.

16. The apparatus of claim 10, wherein the first version of the memory device includes first comparison logic to determine whether a particular address in the first main memory corresponds to a defective storage element, and wherein the second version of the memory device includes less comparison logic than the first comparison logic.

17. The apparatus of claim 16, wherein the second version of the memory device does not include comparison logic.

18. A non-transitory computer-readable medium comprising instructions that, when executed by a processor, cause the processor to:
design a first version of a memory device that includes first main memory and first redundant memory; and
modify a design of the first version of the memory device to produce a second version of the memory device when an error rate associated with fabrication of the first version of the memory device is below a threshold, wherein the second version of the memory device includes second main memory that is logically identical to the first main memory, and wherein the second version of the memory device includes less redundant memory than the first redundant memory.

19. The non-transitory computer-readable medium of claim 18, wherein modifying the design of the first version of the memory device to produce the second version of the memory device includes modifying a first mask associated with the first version of the memory device to generate a second mask associated with the second version of the memory device.

20. The non-transitory computer-readable medium of claim 18, wherein the second version of the memory device does not include redundant memory.
